(19) United States
(12) Patent Application Publication
(10) Pub. No.: US 2011/0096563 A1
(43) Pub. Date: Apr. 28, 2011

(54) METHOD, DEVICE, AND SYSTEM FOR CONTROLLING ENCIRCLED FLUX

(76) Inventors: Piotr Anatolij Levin, Vilnius (LT); Nikolajus Gavrilinas, Vilnius (LT)

(21) Appl. No.: 12/910,064

(22) Filed: Oct. 22, 2010

Related U.S. Application Data
(60) Provisional application No. 61/279,597, filed on Oct. 23, 2009.

(51) Int. Cl. G05D 25/00; G02B 6/36

(52) U.S. Cl. 362/552; 385/76

(57) ABSTRACT

A light module, a fiber optic connector, and a system that each include a screw in communication with an optical fiber that is movable such that the optical fiber may be deformed to a desired level in order to control encircled flux by extinguishing undesired modes of light launched through the optical fiber.

### CLAIM OF PRIORITY

This application claims the benefit of priority of U.S. Provisional Patent Application Ser. No. 61/279,597, filed on Oct. 23, 2010.

### FIELD OF THE INVENTION

The present invention relates to the transmission of optical signals through optical fibers, and in particular to methods, devices and systems for controlling the encircled flux of optical signals transmitted through optical fibers to achieve repeatable, consistent optical fiber testing.

### BACKGROUND OF THE INVENTION

The present invention pertains to transmission of optical signals through optical fibers. Optical signals are transmitted by applying a light source to an optical fiber. The light source and the optical fiber must be appropriately aligned with one another in order to couple as much light as possible into the optical fiber. Light sources may be aligned to two different types of optical fibers, single-mode optical fibers and multi-mode optical fibers. Single-mode optical fibers can accommodate only one mode of light. Multi-mode optical fibers can simultaneously accommodate numerous modes of light. Some of these modes are located near the center of the fiber core and some closer to the cladding interface. The low-order modes are located near the center of the fiber core and are relatively stable as compared to the high-order modes closer to the cladding interface. The modal power distribution, i.e. which modes are excited upon introduction of the light source to the optical fiber, defines the “launch condition.”

Controlling launch conditions helps to control the optical power loss across a fiber link, commonly referred to as “link loss.” It has been found that link loss is directly related to launch conditions and that carefully controlling launch conditions within well defined parameters is one way to stabilize link losses. If the launch condition is such that too many modes are excited, then the optical fiber will be overfilled and produce link loss measurements that are too high. Thus the loss reading may be overestimated, leading to loss value that will not correspond to reality. If the launch condition is such that too few modes are excited, then the optical fiber will be underfilled and produce link loss measurements that are too low. This may produce misleading and overly optimistic results. Therefore, to achieve repeatable, consistent fiber optic testing, it is desirable to control launch conditions such that only the desired modes are excited.

Encircled Flux (EF) is a parameter that characterizes the launch conditions of a multi-mode light source. EF is a radial integration of the power distribution in the optical fiber, going from zero at the center to unity at the core boundary, with a definitive set of radial power templates at 850 nm and 1300 nm. EF describes the intensity of the light encircled within a fiber core radius when light is launched into a multi-mode optical fiber. Thus, EF will vary with changes in light source, optical fiber, or how the light source is coupled with the optical fiber, i.e. the launch conditions.

Controlling launch conditions, and thus EF, can be very challenging. This is especially true considering certain exacting specifications required by the Telecommunications Industry Association (TIA), Electronic Industries Alliance (EIA), and the International Standards Organization (ISO, originator of ISO 14763-3, which details systems and methods to inspect and test optical fiber cabling). Several methods currently exist.

One method for controlling launch conditions is mandrel wrapping. This method is used when a light source, such as LED, emits light over an area larger than the typical multi-mode fiber core. This overfills the core, exciting both low-order and high-order modes. In this situation, the high-order modes may be removed by tightly wrapping the launch cable around an industry standard round mandrel. The tight bends extinguish the undesirable modes leaving the desired launch condition.

Although mandrel wrapping is able to achieve the desired results, this method has its disadvantages. Determining the correct size of the mandrel and how many turns of the mandrel are appropriate can be challenging. Several factors, such as optical fiber characteristics and desired modal distribution must be considered in reaching this decision. Mandrel wrapping is also highly dependent on operator skills for accuracy, as there must be no overlapping turns and no tension beyond that which is required to maintain contact between the optical fiber and the mandrel. Finally, and most importantly, fiber optic equipment manufacturers who design fiber optic light sources for use in their products have recently begun to specify ISO 14763-3 compliance for EF directly from the light source, without the use of external launch manipulation such as mandrel wrapping. Therefore, other methods are needed to comply with these requirements.

One alternative method for controlling launch conditions is described in U.S. Pat. No. 7,139,454. This patent describes an optical element from which light rays may impinge on a core or face of an optical fiber which may be a multimode optical fiber. Rays may propagate through the optical fiber and exit the optical fiber at its core or face as light rays or signals. The light rays or signals may be conditioned into light rays or signals to make high speed transmission through optical fibers or other medium possible. Two characteristics of the optical element, taken singly or in combination, may produce the light launch profile on the fiber face core and maintain robust compliance with the EF conditions of the TIA specification. First, one surface of the optical element may have a slope discontinuity at an optical axis. This characteristic provides an axicon function to the optical element. Second, the optical element is defocused relative to the face of the core at the fiber end.

This method also has drawbacks. Specifically, the optical element in either of the embodiments mentioned above is very delicate. It must be manufactured at significant expense to exacting standards. Any manufacturing imperfection, including scratches, smudges, and thickness variability will render the optical element unusable for its purpose. Moreover, given the precision with which the optical element must be applied to the optical system, even a perfectly manufactured optical element may easily be misaligned or otherwise positioned incorrectly to achieve the desired results.

Other products that control launch conditions include those that use specialty jumpers. One such product is the Arden Photonics “ModCon” modal controller for multimode optical fiber. However, this product is a jumper that is added to a light source and is not adapted to allow a light source to meet the ISO 14763-3 standard for EF directly from the light source without the use of external launch manipulation.

Therefore, there is a need for a method for controlling EF that does not present the aforementioned drawbacks. Unlike mandrel wrapping, it should not be difficult to select the correct equipment and it should not rely heavily on operator skill. Moreover, there is a need for devices that do not use external launch manipulation like mandrel wrapping. Unlike optical elements, the equipment necessary should be inexpensive, not easily damaged, and easy to apply to an optical system.

### SUMMARY OF THE INVENTION

The present invention includes a light module, a fiber optic connector, and a system, each of which includes a movable member, preferably a screw, to controllably deform an optical fiber in order to condition modes. The invention also includes a method for controlling EF through the controlled deformation of an optical fiber.

In its most basic form, the light module is a conventional fiber optic light module that has an output port that includes a substantially hollow casing. An optical fiber passes through the casing of the output port of the light module, which supports the optical fiber at both ends. The casing is dimensioned to align the optical fiber at both ends thereof and to allow the optical fiber to be deformed within the space between the ends of the casing. A screw is threaded through the casing such that it is in contact with the optical fiber. The screw is dimensioned to contact the optical fiber and exert downward pressure upon it when the screw is advanced in order to deform the optical fiber and, consequently, change the EF of the light passing through the optical fiber.

In the preferred embodiment, the light source is a light module commonly used within a fiber optic test instrument. This light module combines one or more beams of light and launches the resultant beam into the optical fiber. This optical fiber extends through the output port of the light module, which includes the casing through which the screw is disposed. A tapered strain relief may be attached to the output port to further guide the optical fiber out of the light module and to aid in alleviating strain on the optical fiber. The optical fiber may then be connected through the fiber optic test instrument to another optical fiber to be tested. After the screw face is polished, the screw is brought into contact with the optical fiber through the output port of the light module and is moved downward to controllably apply pressure on the optical fiber. Other than creating the entry point for the screw through the output port of the light module and polishing the screw face, no further modification to the output port, screw, or optical fiber is necessary. As the casing holds the optical fiber in a substantially fixed position at its entry and exit, this pressure causes the optical fiber to deform and alters the EF of the light passing through the optical fiber.

During manufacture of the light module, the screw may easily be adjusted until the desired EF is achieved, and then permanently affixed in place with epoxy or other known methods of permanently affixing screws in a stationary position. The screw adjustment typically requires three to five turns of the screw once the screw is positioned in contact with the optical fiber. The modified light module, having the affixed screw and the desired EF, is then used within a fiber optic test instrument. Thus, the instrument provides a desired EF without external launch manipulation, like mandrel wrapping, and will produce repeatable, consistent launches with the desired EF in the field.

The fiber optic connector of the present invention adjusts the EF in substantially the same manner as the light module discussed above, but is adapted for external attachment to the fiber port of a conventional fiber optic test instrument. In its most basic form, the connector includes a hollow casing, a fiber port extending from one end of the casing and a fiber port connector extending from the opposite end of the casing and dimensioned to mate with a fiber port of a conventional fiber optic test instrument. The fiber port and fiber port connector each include fiber openings that are aligned with one another. An optical fiber passes through the fiber opening in the fiber port connector and the casing and terminates within the opening in the fiber port. The casing supports the optical fiber at both ends and is dimensioned to align the optical fiber at both ends thereof and to allow the optical fiber to be deformed within the space between the ends of the casing. A screw is threaded through the casing such that it is in contact with the optical fiber. The screw is dimensioned to contact the optical fiber and exert downward pressure upon it when the screw is advanced in order to deform the optical fiber and, consequently, changes the EF of the light passing through the optical fiber until it reaches a desired result.

The fiber port connector of the fiber optic connector is attached to the fiber port of a conventional fiber optic test instrument such that the optical fiber within the fiber optic connector abuts an optical fiber within the fiber port of the test instrument. The instrument is then energized, which causes light to be emitted through the optical fiber within the fiber optic connector. The EF of this light is measured and the screw through the casing is adjusted until the desired EF is achieved. The screw may then be permanently affixed in place with epoxy or other known methods of permanently affixing screws in a stationary position, or it may be left unsecured so that it may subsequently be used with other fiber optic test instruments.

The system of the present invention includes a fiber optic test instrument, either having a light module of the present invention disposed within the fiber optic test instrument's casing, or a fiber optic connector of the present invention attached to the fiber optic test instrument's fiber port, combined with a power meter. In the preferred embodiment of the system, the power meter is a portable power meter, such as is commonly used in the art of fiber optic testing. The fiber optic test instrument and power meter are applied to each end of an optical fiber. The device launches light with a desired EF through the optical fiber and the power meter measures the link loss across that optical fiber. As each launch of the device will have the desired EF, repeatable, consistent testing may be achieved.

The method for controlling EF includes the steps of applying a light through an optical fiber of a light source, disposing a screw through the output port of the light source such that the screw contacts the optical fiber such that it may apply variable pressure on the optical fiber such that it is deformed, and adjusting the screw until the optical fiber is deformed such that the desired EF is obtained.

Therefore, it is an aspect of the invention to provide an inexpensive and robust alternative to current methods and devices for controlling EF.

It is a further aspect of the present invention to provide an alternative to current methods and devices for controlling EF that is easy to use, thus relying little on operator skill.

It is a further aspect of the present invention to provide a method and/or device for controlling EF that may be easily adapted to existing fiber optic testing equipment.

It is a further aspect of the present invention to provide a device that provides launches of a specified EF without external launch manipulation.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWING

FIG. 1 is a cut away side view of a prior art light module.

FIG. 2A is a cut away side view of a light module in accordance with the present invention with the optical fiber in an undeflected position.

FIG. 2B is a cut away side view of a light module in accordance with the present invention with the optical fiber in a deflected position.

FIG. 3 is a cut away side view of a fiber optic connector in accordance with the present invention.

FIG. 4A is a cut away side view of a prior art portable light source having a conventional light module.

FIG. 4B is a cut away side view of a portable light source to which the fiber optic connector of the present invention is attached.

FIG. 5 is a graph showing the measured EF before and after adjustment and the upper and lower limits of acceptable EF.

FIG. 6A is a cut away side view of one embodiment of the system of the present invention in which the light source includes a light module of the present invention.

FIG. 6B is a cut away side view of one embodiment of the system of the present invention in which the light source includes the fiber optic connector of the present invention.

FIG. 7 is a block diagram depicting the steps of the method of the present invention.

### DETAILED DESCRIPTION OF THE INVENTION

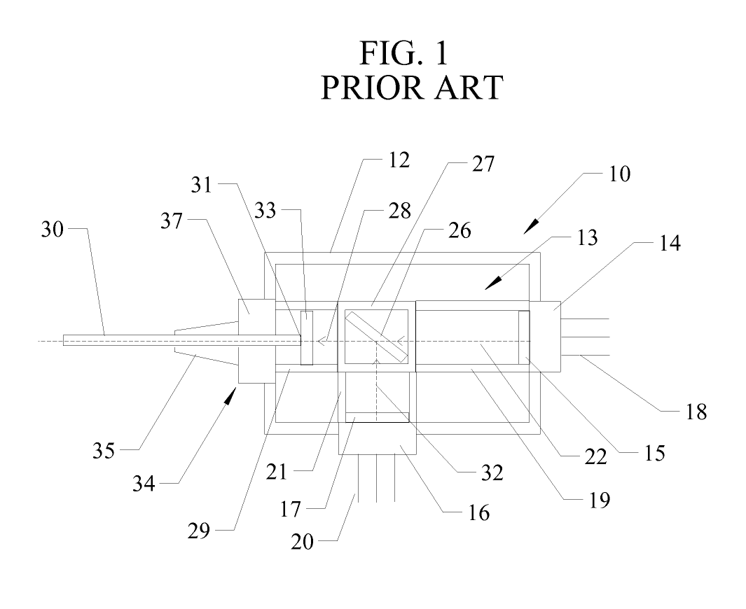

Referring first to FIG. 1, an illustration of a prior art light module 10 is shown. The light module 10 shown in FIG. 1 is a type commonly used within fiber optic test instruments. Examples of such light modules are the FOD 3105 Dual LED Module, the FOD 3206 Laser Diode Module, and the FOD 3226 Triple LD Module, manufactured by Fiber Optic Devices of Vilnius, Lithuania. These light modules may have single or multiple light sources and may produce light of any wavelength. Such a light module may be used within any portable or stationary fiber optic test instrument, such as the EXFO FLS-300 Light Source, the FOD 2114 Triple Laser Light Source, the AFL Telecommunications Noyes® OLS1-Dual LED Light Source with Wave ID, the EXFO IQS-2100 Light Source, and the EXFO FLS-2200 Broadband Source, that may test single or multi-mode optical fibers.

The light module 10 of FIG. 1 is a dual light emitting diode (LED) light module that includes a housing 12, two LEDs 14 and 16 from which power leads 18 and 20 extend respectively, and an output port 34 dimensioned to accept an optical fiber 30. Output port 34 may include a strain relief 35 and an output connector 37 that joins the output port 34 to the housing 12. First LED 14 and second LED 16 extend into the inside 13 of the housing 12 and are disposed such that each is in substantially perpendicular relation to the other. Lenses 15 and 17 are affixed adjacent to LEDs 14 and 16 respectively within the inside 13 of the housing 12. Transparent tubes, preferably glass tubes 19 and 21, connect LEDs 14 and 16 respectively with two sides of transparent glass cube 27. A transparent cube, preferably glass cube 27, surrounds beam splitter 26. Beam splitter 26 is disposed at a location where the beams of light 22, 32 from the first LED 14 and second LED 16 intersect. The beams of light 22, 32 travel through glass tubes 19 and 21 respectively and are directed upon the beam splitter 26, which combines the beams of light 22, 32 and directs a combined beam of light 28 through glass tube 29. Lens 33 is affixed within glass tube 29 such that it is between and parallel to output connector 37 and a side of glass cube 27. The end 31 of the optical fiber 30 may be in contact with lens 33 and extend out of housing 12 through glass tube 29 and output port 34. The combined beam of light 28 then passes through the optical fiber 30 and output port 34.

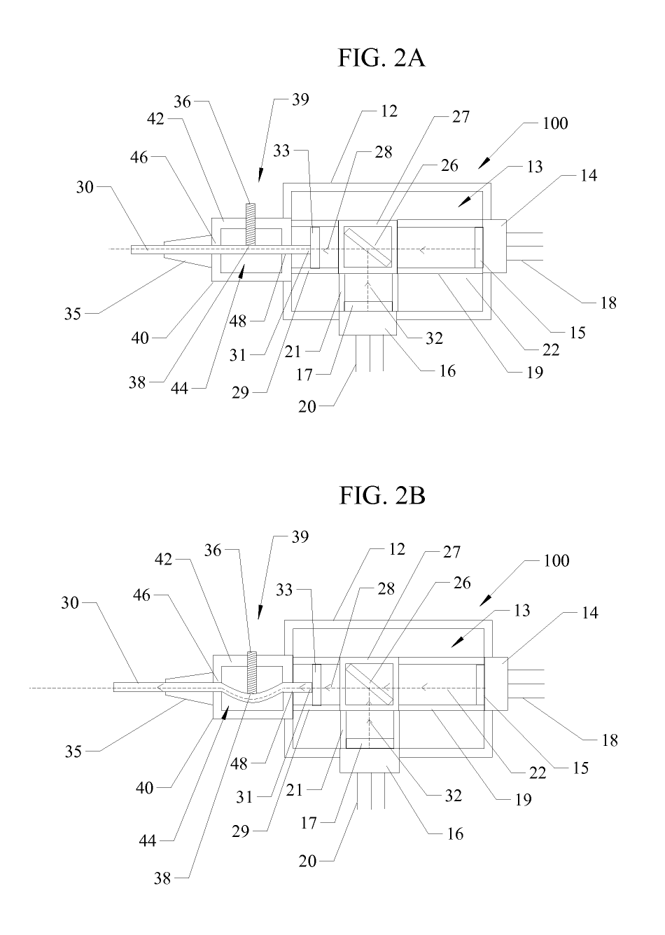

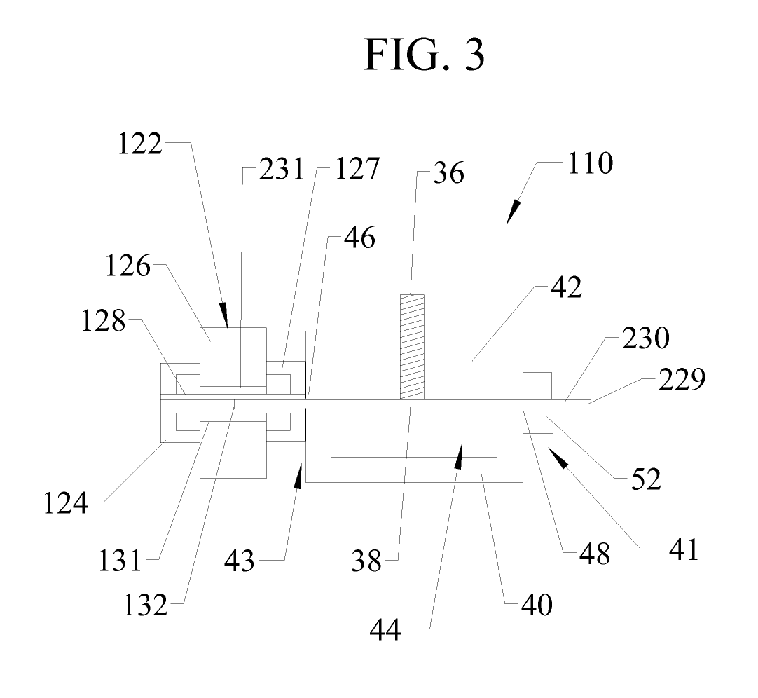

FIGS. 2A and 2B show a light module 100 of the present invention. The light module 100 is substantially the same as the prior art light module 10 except for the replacement of output port 34 with output port 39. Output port 39 preferably includes a strain relief 35 similar to the prior art guide, but replaces the output connector 37 with a substantially hollow casing 40. Casing 40 is attached to housing 12 and includes an exit opening 46 proximate to the strain relief 35 and an entry opening 48 proximate to the housing 12. Exit opening 46 and entry opening 48 are preferably aligned with one another and are each dimensioned to allow the optical fiber 30 to pass therethrough and to support the optical fiber 30 during deformation. Exit opening 46 and entry opening 48 may be lined with rubber bushings (not shown) to further aid in alleviating strain on optical fiber 30. The walls 42 of the casing 40 define a hollow interior 44 that is dimensioned to allow the optical fiber 30 to be sufficiently deformed to allow the EF of the light passing through the optical fiber 30 to be properly adjusted. The interior 44 of the casing 40 shown in FIGS. 2A and 2B extends both above and below the optical fiber 30. However, as illustrated in the connector 110 of FIG. 3, it is recognized that the hollow interior 44 may only be disposed below the optical fiber 30 and that the casing 40 may be substantially solid in the area above the optical fiber 30.

The face 38 of screw 36 is preferably polished prior to being brought in contact with the optical fiber 30. Screw 36 passes through a threaded opening in the wall 42 of the casing 40 and the face 38 of screw 36 contacts the optical fiber 30. Screw 36 may be any type of threaded fastener that may be threaded into and out of the wall 42 of the casing 40 and that will not damage the optical fiber 30 during contact therewith, but is preferably an Allen-style M 1.6 screw without head and with a polished face 38. As shown in FIG. 2A, when the optical fiber 30 is in an undeformed position, it is substantially straight through the entry opening 48 and exit opening 46 across its entire length. As the screw 36 is threaded into the interior 44 of the casing 40, the face 38 of the screw 36 exerts downward pressure on optical fiber 30 so as to depress the optical fiber 30 downward into the interior 44 of the casing 40. Because the optical fiber 30 is supported by the entry opening 48 and exit opening 46, the portion of the optical fiber 30 between the entry opening 48 and exit opening 46 becomes deformed downward in the manner shown in FIG. 2B. The adjustment of the position of screw 36, and resultant deformation of the optical fiber 30, changes the EF of the beam of light 28 within optical fiber 30. Thus, screw 36 is incrementally adjusted, while the EF of beam of light 28 through the optical fiber 30 is assessed, until the desired EF is obtained. Once the desired EF is obtained, screw 36 may be affixed in such position by any means commonly used for such affixation, such as soldering, gluing, or by known mechanical means, such as a locking pin or screw.

A test instrument that includes the light module 100 of the present invention will meet the specifications for EF without the use of additional devices, such a mandrel wrapping, and will emit consistent launch conditions with the desired EF, thus providing repeatable, consistent fiber optic testing.

The present invention also includes a fiber optic connector 110 that is adapted to attach to a fiber port of an existing test instrument. As shown in FIG. 3, the fiber optic connector 110 is similar to the output port 39 of the light module 100 of FIGS. 2A and 2B insofar as it includes a substantially hollow casing 40 having a first casing end 41, a second casing end 43, a casing interior 44, an entry opening 48, an exit opening 46, and screw 36 that is threaded through the wall 42 of the casing 40. However, it also includes a fiber port connector 52, shown as a male fiber port connector in FIG. 3, attached to one end of the casing 40, a fiber port 122 attached to the opposite end of the casing 40 and an optical fiber 230 that terminates within the fiber port 122 and extends through the casing 40 and out of the connector 110 through an opening in the fiber port connector 52.

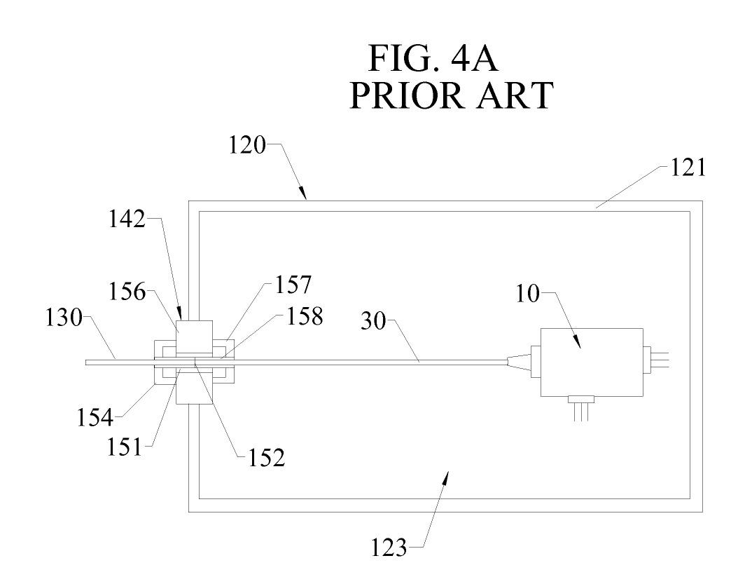

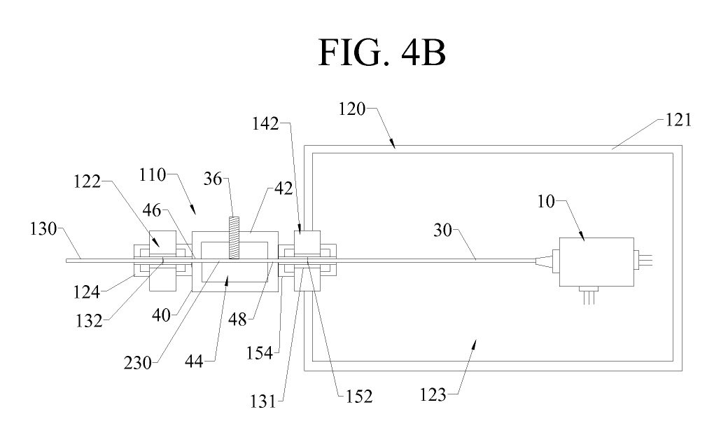

The fiber port 122 is preferably an industry standard port for connecting an optical fiber to a test instrument. Fiber port 122 includes a body 126 and a ceramic tube 131 disposed through an opening in the body 126. A fiber guide 128 is disposed through the ceramic tube 131 and extends through fiber port connectors 127 and 124, which extend from each end of the body 126. Optical fiber 230 is disposed through the fiber guide 128 and terminates at a second end 231 at a fiber junction 132 within the fiber guide 128 and at a first end 229 at a position outside of the fiber port connector 52 that allows the optical fiber 230 to be inserted within the fiber port of the test instrument (shown in FIG. 4B). Fiber port connector 52 is dimensioned to mate with and secure the fiber optic connector 110 to a fiber port of an existing fiber optic test instrument (shown in FIG. 4B). In FIG. 3, fiber port connector 52 is a threaded male fiber port connector. However, it is recognized that other types of fiber port connectors may be substituted to achieve similar results.

The walls 42 of the casing 40 define a hollow interior 44 that is dimensioned to allow the optical fiber 230 to be sufficiently deformed to allow the EF to be properly adjusted. In the embodiment of FIG. 3, the hollow casing interior 44 of the casing 40 is only disposed below the optical fiber 230 and the casing 40 is substantially solid in the area above the entry opening 48 and exit opening 46. However, as shown in FIG. 4B, the casing interior 44 of the casing 40 may extend above the entry opening 48 and exit opening 46.

The operation of the fiber optic connector 110 of the present invention is illustrated with reference to FIGS. 4A and 4B. FIG. 4A shows a prior art portable light source 120, which is a fiber optic test instrument commonly used in fiber link loss measurement on both single and multi-mode optical fibers. Examples of such portable light sources include the EXFO FLS-300 Light Source, the FOD 2107 LD Light Source, the AFL Telecommunications Noyes® OLS1 LED Light Source, the FOD 2114 Triple Laser Light Source, the AFL Telecommunications Noyes® OLS1-Dual LED Light Source with Wave ID, and the FOD 2119C ASE Light Source C-Band. These light sources or fiber optic test instruments are handheld and designed to perform link loss measurements when used in conjunction with an optical power meter. Specifically, they may test Ethernet, Gigabit Ethernet (GBE), Token Ring, and other multi-mode LAN systems, and Passive Optical Networks (PONs). The results of the tests may be used to certify the optical fiber for TIA/EIA or ISO standards. Some of these light sources may be paired with an optical fiber identifier, in which case they may perform the further function of fiber identification prior to splicing.

The portable light source 120 of FIG. 4A includes a substantially hollow housing 121 having an interior 123 within which a light module 10 is disposed. An optical fiber 30 extends through the housing 121, from the light module 10 to its termination within a fiber port 142. Fiber port 142 is an industry standard port that may include a body 156, a fiber connector 157 disposed in the interior 123 of housing 121, a fiber guide 158, a ceramic tube 151, and a fiber port connector 154 extending from the body 156 outside of the housing 121. Body 156 immediately surrounds ceramic tube 151, which immediately surrounds fiber guide 158. Optical fiber 30 is extended from the interior 123 of housing 121 through first fiber port connector 157 and fiber guide 158 to fiber junction 152. An optical fiber 130 to be tested is coupled with the fiber port connector 154 such that optical fiber 130 extends within the fiber port 142 and, specifically, within the fiber guide 158, and is joined to optical fiber 30 at fiber junction 152 such that the light passing through optical fiber 30 also passes through optical fiber 130.

The housing 121 of light source 120 is preferably box-like, made of plastic, and small enough to be handheld. The exterior of the light source 120 may also include at least one control button and a screen (not shown), which may display information such as pass/fail results, emitted wavelengths, tone frequency, and battery condition. The interior 123 of the housing 121 of the light source 120 may also include a battery (not shown) and other art recognized electronics (not shown) for controlling the operation of the light source 120.

FIG. 4B shows the portable light source 120 with a fiber optic connector 110 of the present invention attached to the fiber port 142. In this embodiment, the fiber optic connector 110 is attached to the fiber port 142 of the light source 120 such that the optical fiber 230 of the fiber optic connector 110 extends within fiber port 142 and is joined to optical fiber 30 at fiber junction 152 such that the light passing through optical fiber 30 also passes through optical fiber 230. The light source 120 is then energized, and screw 36 is moved downward to apply pressure upon the optical fiber 230, causing it to deform in the manner shown in FIG. 2B. The EF of the light passing through the optical fiber 230 is then measured and the screw 36 is adjusted until the EF is at a desired level. The screw 36 may then be permanently affixed in place or it may be left unsecured so that it may subsequently be used with other fiber optic test instruments. Once the fiber optic connector 110 has been used to properly adjust the EF of the light, the light source 120 with fiber optic connector 110 may be used in a conventional manner except that, rather than joining the optical fiber 130 to be tested with the optical fiber 30 within fiber port 142, the optical fiber 130 to be tested extends within fiber port 122 and is joined to optical fiber 230 at fiber junction 132 such that the light passing through optical fiber 230 also passes through optical fiber 130.

As noted above, EF is a radial integration of the power distribution in an optical fiber, going from zero at the center to unity at the core boundary. EF describes the intensity of the light encircled within a fiber core radius when light is launched into a multi-mode optical fiber. There are a number of devices currently available to measure EF, including the MPX Modal Explorer manufactured by Arden Photonics, Ltd. of Great Britain, the 2440 Launch Analyzer manufactured by Photon Kinetics, Inc. of Beaverton, Oreg., and others, and any of these devices may be used to measure EF in connection with the adjustment of EF performed in connection with the present invention.

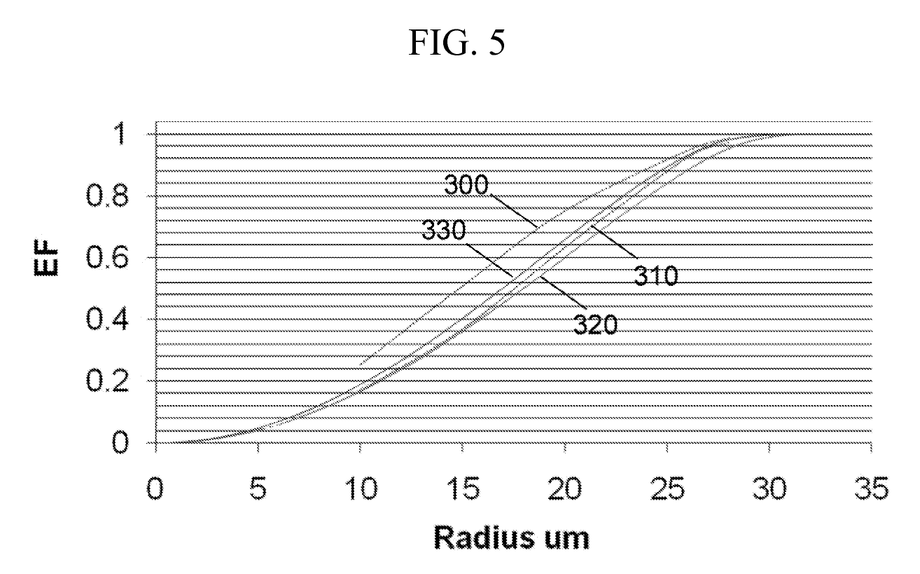

Referring now to FIG. 5, EF is typically measured and displayed by current devices with reference to a graph showing the EF on the Y-axis and the radius of the fiber on the X-axis. Current standards place an upper limit and a lower limit on the EF as a function of the radius.

The upper limit on EF that complies with the current standards is shown as plot 300 in FIG. 5, while the lower limit is shown as plot 310. In practice, the EF will be measured before it is adjusted and plot 320 is exemplary of the results of such a pre-adjustment measurement. During adjustment, EF will be continually measured until it is shown to, in all respects, fall within the upper limit plot 300 and lower limit plot 310 in the graph. Plot 330 is an exemplary plot for EF after it is fully adjusted.

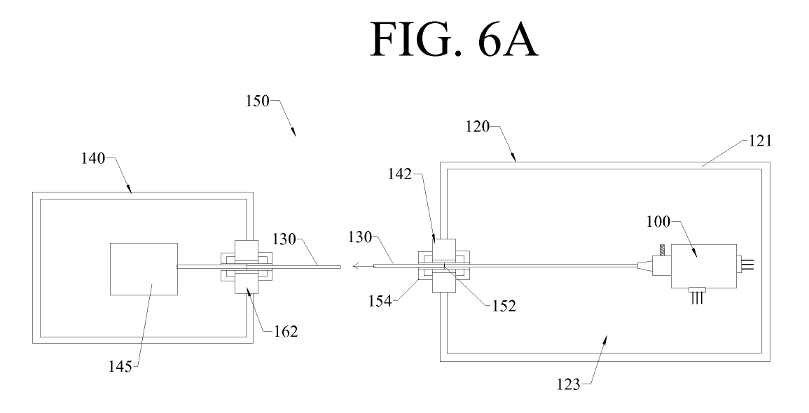

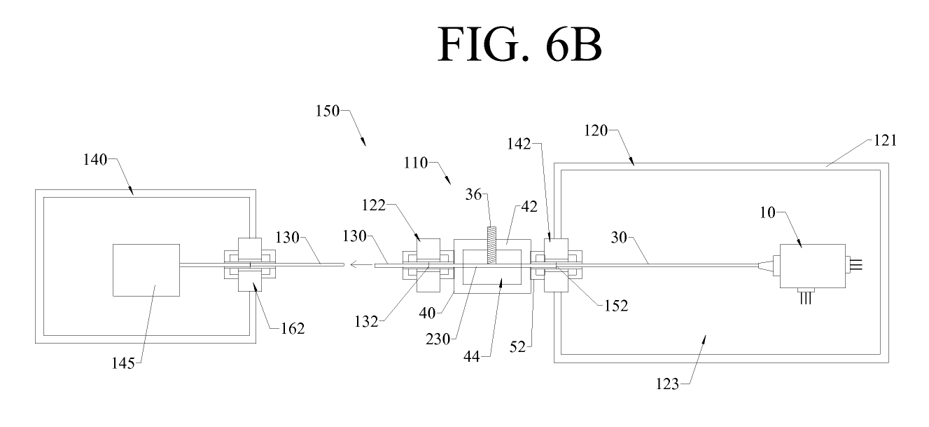

FIGS. 6A and 6B illustrate two embodiments of the system 150 of the present invention. This system 150 includes a light source 120, a power meter 140, and an optical fiber 130 to be tested. In FIG. 6A, light source 120 includes the light module 100 of the present invention. In FIG. 6B, a conventional light source 120 is modified by attaching the fiber optic connector 110 of the present invention thereto.

Power meter 140 may be any of those commonly used in link loss measurement, such as the FOD 1202 Triple Wavelength Power Meter, the EXFO FiberBasix EPM-100 Power Meter, the FOD 1206 Optical Return Loss Meter, the AFL Telecommunications Noyes® OPM1 Optical Power Meter, the FOD 1203 Optical Tester, the EXFO PM-1100 Power Meter, and the EXFO PM-1600 High-Speed Power Meter, and includes a fiber port 162 that may be substantially identical to the fiber port 142 described with reference to the light source 120, and an internal device 145 for measuring the optical power of the light through the optical fiber 130. The optical fiber 130 being tested for link loss may be among a class of optical fibers that include single or multi-mode; of short or long distance; Ethernet, GBE, or other LAN systems. Light source 120 and power meter 140 may be applied to either end of the optical fiber 130 that is to be tested.

In each embodiment of the system, the EF from the light source 120 has been controlled by adjusting the screw 36 of either the light module 100 or the fiber optic connector 110 of the present invention such that the light launched into the optical fiber 130 has an EF that is within the upper and lower limits of the applicable standards. Accordingly, the power meter 140 will provide repeatable, consistent measurements of link loss across optical fiber 130 without the need for mandrel wrapping or other methods of controlling EF.

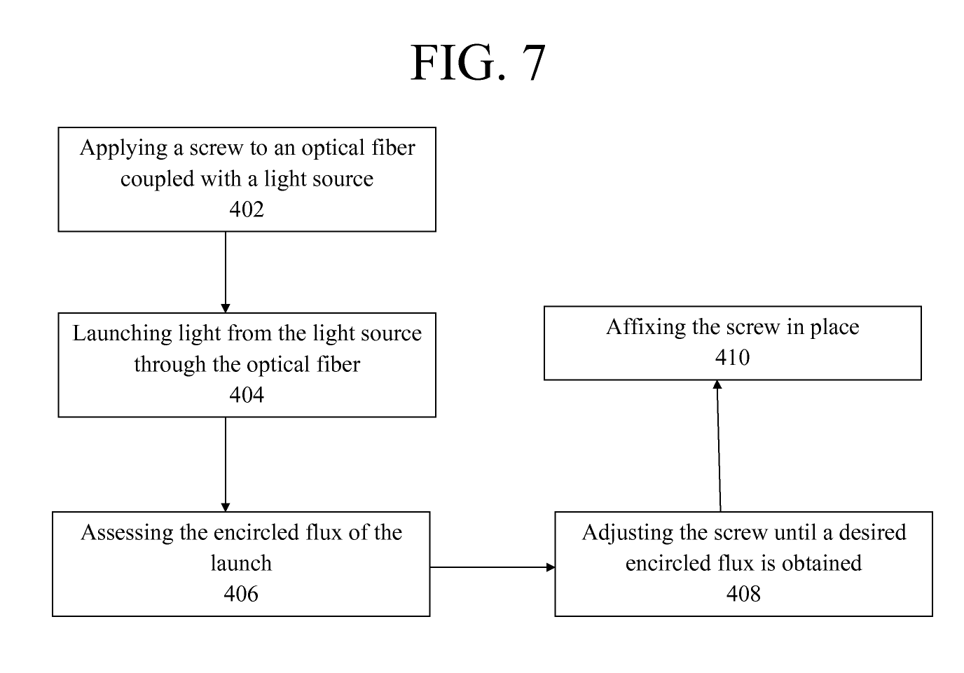

In another embodiment of the present invention, a method for controlling EF is provided. FIG. 7 is a block diagram depicting the steps of method 400. The steps method 400 include applying a screw to an optical fiber coupled with a light source 402, where the application and light source are as described above with reference to either FIGS. 2A and 2B or FIGS. 3 and 4B; launching a beam of light through the light source 404; assessing the EF of the launch 406; and adjusting the screw until a desired EF is obtained 408. The method may further include the step of affixing the screw in place once a desired EF is obtained 410.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. A light module for use in a fiber optic test instrument, wherein said light module emits light with a desired encircled flux, said light module comprising:
a substantially hollow housing comprising an inside;
a light source disposed inside said housing, wherein said light source emits light;
an output port attached to said housing, wherein said output port comprises a substantially hollow casing having an interior, an exit opening, an entry opening, and at least one wall through which a threaded opening is disposed;
an optical fiber that extends through said interior of said casing and is substantially supported by said exit opening and said entry opening of said casing, wherein said optical fiber comprises an end that is disposed within said inside of said housing and positioned in light receiving relation to said light from said light source such that said light passes through said optical fiber; and
a screw comprising a face, wherein said screw is dimensioned to mate with said threaded opening through said at least one wall of said casing and is dimensioned and positioned such that advancing said screw into said interior of said casing causes said face of said screw to contact said optical fiber and to exert sufficient downward pressure upon said optical fiber to depress said optical fiber downward into said interior of said casing a distance sufficient to change an encircled flux of said light passing through said optical fiber.

2. The light module as claimed in claim 1, wherein said light source comprises at least two light emitting diodes and wherein said light module further comprises:
at least two first lenses disposed within said inside of said housing such that light emitted by said at least two light emitting diodes passes through said two first lenses;
a beam splitter disposed within said inside of said housing and in a path of light emitted by said light emitting diodes, wherein said beam splitter is adapted to direct light; and
a second lens disposed within said inside of said housing such that light directed by said beam splitter passes through said second lens; and
wherein said end of said optical fiber is in physical contact with said second lens.

3. The light module as claimed in claim 2, further comprising:
a transparent cube disposed within said inside of said housing, wherein said beam splitter is disposed within said cube;
a transparent first tube disposed between and adjacent to one of said at least two light emitting diodes and said cube, wherein one of said at least two first lenses is affixed within said first tube and light emitted by said one of said at least two light emitting diodes travels through said first tube;
a transparent second tube disposed between and adjacent to another of said at least two light emitting diodes and said cube, wherein another of said at least two first lenses is affixed within said second tube and light emitted by said another of said at least two light emitting diodes travels through said second tube; and
a transparent third tube disposed between and adjacent to said cube and said output port, wherein said second lens is affixed within said third tube and light directed by said beam splitter travels through said third tube.

4. The light module as claimed in claim 1, wherein said output port further comprises a strain relief affixed to said exit opening of said casing such that said optical fiber passes through and is supported by said strain relief

5. The light module as claimed in claim 1 wherein said face of said screw is polished so as to not damage said optical fiber during contact therewith.

6. The light module as claimed in claim 1 wherein said screw is permanently affixed within said threaded opening through said casing.

7. The light module as claimed in claim 1 wherein said interior of said casing extends both above and below said optical fiber.

8. The light module as claimed in claim 1 wherein said interior of said casing extends only below said optical fiber.

9. The light module as claimed in claim 1 further comprising at least one bushing disposed within at least one of said exit opening and said entry opening of said casing.

10. A fiber optic connector for attachment to an instrument fiber port of a fiber optic test instrument through which light passes, said fiber connector comprising:
a casing comprising a first casing end, a second casing end, a casing interior, an entry opening at said first casing end, an exit opening at said second casing end, and at least one wall through which a threaded opening is disposed;
a fiber port connector attached to said casing at said first casing end and dimensioned to be detachably connectable to the instrument fiber port of the fiber optic test instrument;
a fiber port attached to said casing at said second casing end, wherein said fiber port is shaped and dimensioned to detachably connect to a second connector through which a tested optical fiber extend;
a connector optical fiber extending from said fiber port connector at said first fiber end, through said entry opening, said casing interior, and said exit opening, and ending in abutting relation to the tested optical fiber within said fiber port:
said first fiber end is positioned within said first connector such that when said connector is detachably connected to the first fiber port of the fiber optic test instrument, the fiber optic test instrument launches light onto said second optical fiber; and
a screw comprising a face, wherein said screw is dimensioned to mate with said threaded opening through said at least one wall of said casing and is dimensioned and positioned such that advancing said screw into said interior of said casing causes said face of said screw to contact said connector optical fiber and to exert sufficient downward pressure upon said connector optical fiber to depress said optical fiber downward into said interior of said casing a distance sufficient to change an encircled flux of light passing through said connector optical fiber.

11. The fiber optic connector as claimed in claim 10, wherein said face of said screw is polished so as to not damage said connector optical fiber during contact therewith.

12. The fiber optic connector as claimed in claim 10 wherein said screw is permanently affixed within said threaded opening through said casing.

13. The fiber optic connector as claimed in claim 10 wherein said interior of said casing extends both above and below said optical fiber.

14. The fiber optic connector as claimed in claim 10 wherein said interior of said casing extends only below said optical fiber.

15. The light module as claimed in claim 1 further comprising at least one bushing disposed within at least one of said exit opening and said entry opening of said casing.

16. A method for controlling an encircled flux of light passing through an optical fiber comprising the steps of:
applying a downward force to an optical fiber that is in light transmitting relationship with a light source;
launching light from the light source through the optical fiber;
assessing the encircled flux of the light; and
adjusting the downward force until a desired encircled flux of the light is obtained.

17. The method as claimed in claim 16 wherein said step of applying a downward force comprises the step of advancing a screw and wherein said method further comprising the step of affixing the screw in place once a desired encircled flux is obtained.

18. The method as claimed in claim 16 wherein said step of applying a downward force comprises the step of advancing a screw, wherein said optical fiber is an optical fiber the forms a part of a light module and wherein said method further comprises the steps of:
assembling said light module;
attaching said light module to source of power; and
affixing the screw in place once a desired encircled flux is obtained.

19. The method as claimed in claim 16 wherein said step of applying a downward force comprises the step of advancing a screw, wherein said optical fiber is an optical fiber the forms a part of fiber optic connector joining a light source and a power meter, and wherein said method further comprises the steps of attaching the fiber optic connector to the light source.

20. The method as claimed in claim 19 further comprising the step of affixing the screw in place once a desired encircled flux is obtained.
